(19) United States
(12) Patent Application Publication
(10) Pub. No.: US 2005/0120991 A1
(43) Pub. Date: Jun. 9, 2005

(54) Intake system with pressure accumulator

(75) Inventors: Helmut Neuschwander, Ludwigsburg (DE); Eckehart Mandel, Ludwigsburg (DE); Christoph Schuster, Brackenheim (DE)

Correspondence Address: CROWELL & MORING LLP;INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 10/953,886

(22) Filed: Sep. 30, 2004

(30) Foreign Application Priority Data
Oct. 2, 2003 (DE) DE 203 15 244.1

(51) Int. Cl. F02M 35/104

(52) U.S. Cl. 123/184.47; 123/184.61

(57) ABSTRACT

An air intake system for an internal combustion engine having an air collector into which combustion air is introduced and having at least one intake manifold which branches off from the air collector and which can be connected to the internal combustion engine, in which the intake system additionally includes at least one pressure accumulator which is connected in one piece to the intake system.

### BACKGROUND OF THE INVENTION

This invention relates to an intake system for an internal combustion engine having an air collector into which combustion air is introduced and at least one intake manifold which branches off from the air collector and is connected to the internal combustion engine.

Intake systems often require a vacuum accumulator to be able to drive actuators or adjusting elements with vacuum which is made available from the accumulator as needed. Vacuum is therefore withdrawn from the vacuum accumulator through a suitable valve and supplied through lines to the respective switch element. For this purpose, the additional storage mechanism is connected to the existing intake line as a separate component by fastening screws, or—if the accumulator is integrated into the intake system—it may be closed in an air-tight manner with a cover or hood to realize the vacuum storage space.

Published German patent application no. DE 197 28 600 A1 discloses a compact embodiment of an intake system having an integrated storage volume, in which the vacuum storage volume is formed by various parts of the housing walls of the intake system. Several gaskets are provided at the interfaces of the respective housing walls in order to assure an adequate seal with respect to the environment. One disadvantage of this system is the complicated design and the unavoidable use of multiple gaskets, which always entails the problem of possible leakage.

### SUMMARY OF THE INVENTION

The object of this invention is to provide an improved air intake system for use with an internal combustion engine.

Another object of the invention is to provide an air intake system which is highly compact.

A further object of the invention is to provide an air intake system which can be manufactured at a comparatively low cost.

It is also an object of the invention to provide an air intake system with a vacuum storage mechanism.

An additional object of the invention is to provide an air intake system which assures simple but reliable sealing.

These and other objects have been achieved in accordance with the present invention by providing an intake system for an internal combustion engine comprising an air collector into which combustion air is introduced, at least one intake manifold which branches off from the air collector for connection to the internal combustion engine, and at least one accumulator, wherein the accumulator is connected integrally in one piece with the intake system.

The intake system of the invention for use with an internal combustion engine comprises an air collector, an intake manifold and an accumulator, in which the combustion air flows into the air collector and can be sent on to the internal combustion engine via at least one intake manifold which can be connected to the internal combustion engine. The accumulator is connected in one piece to the intake system. This means that it does not comprise a separate housing which is screwed onto the rest of the system or flange-mounted on the rest of the system. Nor does it comprise an extra cover or an extra hood on the intake system. Instead, it is integrated directly into the intake system without the assistance of extra components. This has the advantage that no additional components which must be connected to the intake system in a subsequent operation are needed and no sealing measures such as sealing rings or O-rings are necessary for sealing the accumulator with respect to the environment. It is also clear that this yields an inexpensive improvement over the prior art.

According to one advantageous embodiment of this invention, the air collector, intake manifold and storage mechanism are made of shells with a common parting plane. This parting plane divides the intake system into at least two housing shell parts. From the standpoint of manufacturing technology, it is more advantageous to divide the intake system into multiple housing shell parts so that it is possible to manufacture the individual housing shell parts easily and inexpensively. The housing shell parts may be made of synthetic resin materials, i.e., plastics, or of metals. The important thing is to select compatible materials so that it is possible either to connect the housing shell parts together in an air-tight manner by form-fitting joining methods, or to create a tight connection by establishing a frictionally locked connection using, for example, fastening screws, etc.

When the housing shell parts are joined, the intake system forms an air collector which is connected to the at least one intake manifold and, separately from that, a sealed accumulator, but the accumulator is also formed only from the housing shell parts. This has the advantage that the number of parts required for producing such an intake system is minimized.

According to another advantageous embodiment of this invention, the accumulator is situated on the air collector. In this case the accumulator is a chamber which is integrally incorporated into the housing of the air collector but is sealed with respect to the volume of the air collector.

According to yet another embodiment of this invention, the accumulator is arranged on the intake manifold, where it may form a type of secondary line of the intake manifold but is separated with a seal from the volume of the intake manifold and from the volume of the air collector. Which of these embodiments is used will depend greatly on the spatial particulars in the area of the internal combustion engine, so a different arrangement may be appropriate from one case to the next.

It is advantageous to make the housing shell parts of a synthetic resin material and to join them inseparably to one another in an air-tight manner by vibration welding. In this way, the intake system has a very low weight and it is simple and inexpensive to manufacture, and no additional seals are required to separate the different volumes from one another. In an appropriate arrangement of the parting plane, the connection due to the vibration welding process yields an inseparable connection of the housing shell parts to one another, forming a very tight seal.

It also is advantageous to separate the accumulator from the air collector by a common web, with the parting plane running transversely to the web and through it. Due to the fact that the form-fitting connection of the housing shell parts is accomplished via the parting plane, this type of separation of accumulator and air collector by the web assures that these two volumes are separated from one another in an air-tight manner. This is also independent of the type of joint to be selected. The housing shell parts may thus be joined together by vibration welding, laser beam welding, adhesive methods or other methods known in the art, but this type of arrangement of the parting plane also prevents a transfer of gas between the two volumes.

According to a still further advantageous embodiment of this invention, the intake system is formed by at least two housing shell parts with the accumulator arranged in the vicinity of the air collector and has a first connection which is connected to the air collector and has at least one second connection which is connected correspondingly to an adjusting element. The adjusting element may be a throttle valve, an actuating shaft or something similar. A vacuum may also be created in the accumulator via the first connection connecting the accumulator to the air collector and via the vacuum prevailing in the air collector during operation of the internal combustion engine. The connection may also be established via a valve, such that the vacuum built up in the accumulator can be controlled through the valve. This vacuum is then controlled and used to operate the adjusting element via the second connection.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawing figures in which:

FIG. 1 shows a schematic view of an intake system according to the present invention for an internal combustion engine, and

FIG. 2 shows a section through the air collector and the accumulator of the intake system according to FIG. 1.

In the figures like components are identified by the same reference numerals.

### DETAILED DESCRIPTION OF PREFERRED EMBODIMENTS

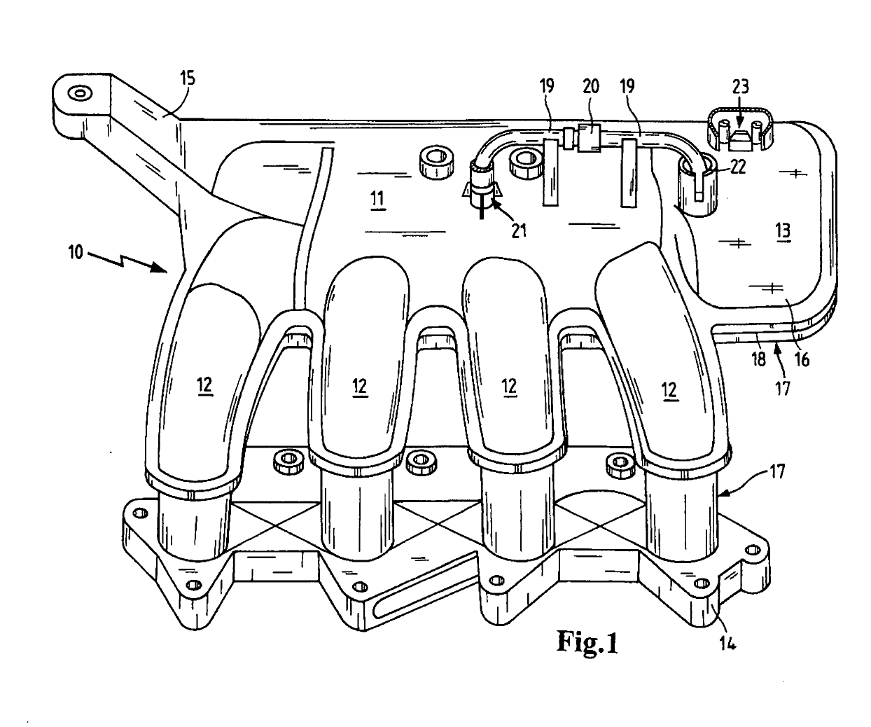

The intake system 10 shown in FIG. 1 for an internal combustion engine comprises an air collector 11, a plurality of intake manifolds 12 branching off from the air collector 11, and an accumulator 13 situated on the air collector 11. The intake manifolds 12 open into a connection flange 14 which serves to mount the intake system on an internal combustion engine (not shown). The intake manifolds 12 here are assigned to the particular cylinders of the internal combustion engine. In the example shown here, the intake system is made of synthetic resin material (i.e. plastic), which can be joined well by vibration welding. A particularly preferred synthetic resin is reinforced nylon, for example, a PA6 GF30 resin [nylon 6 with 30% fiberglass].

A mounting flange 15 is provided on the air collector 11. This mounting flange 15 optionally serves either for further fastening of the intake system 10 or to accommodate additional functional components. The intake system is divided into an upper housing shell part 16 and a lower housing shell part 17 with the parting plane 18 running between the two shell parts. The two housing shell parts 16 and 17 are welded together in the area of the parting plane 18 by vibration welding.

A vacuum line 19, in which a valve 20 is situated, connects the accumulator 13 to the air collector 11. The vacuum line 19 is also connected to a connection 21 of the air collector 11 on the one end and to a connection 22 of the accumulator 13 on the other end. The vacuum which usually prevails in the air collector 11 is thus used here to generate and maintain a vacuum in the accumulator 13. In addition, a connection 23 for an adjusting element (not shown here) is also provided on the accumulator 13, so that the vacuum from the accumulator 13 can be used to operate the adjusting element.

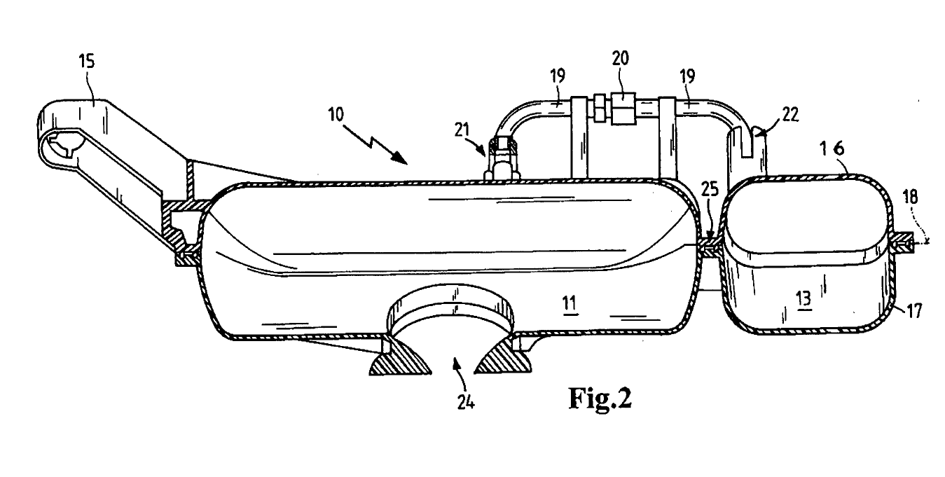

FIG. 2 shows a sectional view through the air collector 11 and the accumulator 13. An intake 24 is situated in the lower area of the accumulator 11 through which the intake air enters after having been cleaned by passing through a filter (not shown here). In this figure, the seal between the air collector and the accumulator 13 can be seen clearly. Although the two volumes are joined together in one piece, they are separated by a web 25. As the figure shows, the web 25 is divided horizontally, i.e. across the direction of the web, by the parting plane 18. When the two housing shell parts 16, 17 are joined by vibration welding, a weld is also formed in the web 25, thereby assuring a secure seal between the air collector 11 and the accumulator 13.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

1. An intake system for an internal combustion engine comprising an air collector into which combustion air is introduced, at least one intake manifold which branches off from the air collector for connection to the internal combustion engine, and at least one accumulator, wherein the accumulator is connected integrally in one piece with the intake system.

2. An intake system according to claim 1, wherein the air collector, the intake manifold and the accumulator have a common parting plane, and wherein the parting plane divides the intake system into at least two housing shell parts.

3. An intake system according to claim 1, wherein the accumulator is arranged on the air collector.

4. An intake system according to claim 1, wherein the accumulator is arranged on the intake manifold.

5. An intake system according to claim 2, wherein the housing shell parts are made of synthetic resin material and are inseparably joined together in an air-tight manner by vibration welding.

6. An intake system according to claim 2, wherein the accumulator is separated from the air collector by a common web, and the parting plane between the housing shell parts extends transversely to the web and through the web.

7. An intake system according to claim 1, wherein the intake system is formed by two housing shell parts, the accumulator is arranged adjacent the air collector and has a first connection which is connected to the air collector and a second connection which is connected with an adjusting element.
